(19) United States
(12) Patent Application Publication
(10) Pub. No.: US 2025/0124234 A1
(43) Pub. Date: Apr. 17, 2025

(54) AUTOMATICALLY UPDATING PROMPTS IN RESPONSE TO DATA DRIFT

(71) Applicant: Dell Products L.P., Round Rock, TX (US)

(72) Inventors: Karen Braga Enes, Belo Horizonte (BR); Pablo Nascimento da Silva, Niterói (BR); Karen Stéfany Martins, Belo Horizonte (BR); Iam Palatnik de Sousa, Rio de Janeiro (BR)

(21) Appl. No.: 18/484,964

(22) Filed: Oct. 11, 2023

(51) Int. Cl. G06F 40/40

(52) U.S. Cl. CPC G06F 40/40

(57) ABSTRACT

Techniques for correcting data drift of a language model are disclosed. A model is built, and this model is designed to solve a same task for which the language model has been trained. The model is applied to new input data. This application results in generation of a prediction comprising predicted label data. Context is stored in a context management structure (CMS). The context includes a prompt template, a prediction, and labeled input data used to train the language model. The data drift is determined to have occurred. This determination is performed by determining that the context is within a threshold level of similarity to a previously stored context. In response to determining that the data drift has occurred, an operation is performed to correct the data drift.

### FIELD OF THE INVENTION

Embodiments of the present invention generally relate to correcting data drift. More particularly, at least some embodiments of the invention relate to systems, hardware, software, computer-readable media, and methods for automatically updating a language model's prompts to mitigate data drift.

### BACKGROUND

Prompt-learning is a recent paradigm for Natural Language Processing (NLP) problems based on Language Models (LM). The main idea of prompt-learning is to reformulate downstream tasks to look more like those solved during the original training of the LM via the help of a textual prompt. By selecting the appropriate prompt, it is possible to manipulate the model's behavior so that the pre-trained LM can be used to predict the desired output, without any additional task-specific training.

Therefore, a single LM trained in an unsupervised fashion can be used to solve a large number of tasks. In addition, this technology allows for the drastic reduction in storage costs for multiple tasks, since only prompts are stored for each individual task.

This kind of training can have many uses. For example, the development and success of a machine learning model are directly related to the data available for training the task. When a model is deployed into production, the predictions are correct only if the data submitted to the model in production mimics the data used in training. When this does not happen, there is a data “drift.”

When data drifts are not identified on time, the predictions will go wrong, and the business decisions taken based on the predictions may have a negative impact. Accordingly, there is a substantial interest in building machine learning models that are robust enough to identify and dynamically correct data drift.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of prompt learning.

FIG. 2 discloses aspects of AutoPrompt.

FIG. 3 illustrates various phases for responding to data drift.

FIG. 4 illustrates a context management structure (CMS).

FIG. 5 illustrates operations for training a language model.

FIG. 6 illustrates the operations of phase one.

FIG. 7 illustrates the operations of phase two.

FIG. 8 illustrates the operations of phase three.

FIG. 9 illustrates a flowchart of an example method for responding to data drift.

FIG. 10 illustrates an example computer system that can be configured to perform any of the disclosed operations.

### DETAILED DESCRIPTION OF SOME EXAMPLE EMBODIMENTS

The disclosed embodiments are beneficially able to automatically identify and correct data drift problems that occur over time. These corrections are performed using prompt engineering. Generally, the embodiments rely on an automatic prompt generation model that is able to identify and reinforce the context of data over time. This model stores previous contexts to adapt or reinforce the current context in the current time step, particularly as the performance of the original predictive model decays. In this way, the disclosed techniques are able to automatically update prompts when a data drift scenario is identified or in the case where the performance of the model is degrading over time. These updates are facilitated by identifying context changes that previously required human effort to analyze the data.

It is often the case that data drift is manageable by retraining the entire model, which in many cases, is computationally expensive. Prior to the retraining event, the predictive model may cause wrong decisions, however. Data drift can also be manageable by fine tuning the predictive model, which requires storing large LM checkpoints for each individual task. Notably, most LMs require complex systems and huge computational power and can take months to train. By following the disclosed principles, the embodiments are beneficially able to prevent retraining and fine-tuning of predictive machine learning models.

The embodiments are also beneficially able to identify context changes in data in NLP tasks. Historically, such identification required human effort to analyze the data.

As yet another benefit, the embodiments are able to automatically address data drift. For instance, the embodiments can determine how best to store different contexts. The embodiments are also able to determine how to adapt the input data to a new context or to reinforce a previous one. Accordingly, these and numerous other benefits will now be described in more detail throughout the remaining sections of this disclosure.

### Prompt Based Learning

Recently, the pre-train and fine-tune paradigm has changed to “pre-train, prompt, and predict,” and now state of the art methods are based on prompt-based learning. In this new paradigm, downstream tasks are reformulated to look like the task learned during the original training of the LM. To do that, the text input is modified using prompts. It allows large LMs to generalize to tasks that they were not trained on, with minimal data and performance comparable to fine-tuning the LM model to the target task. Unlike the last paradigm, a single pre-trained model can be applied to different tasks, reducing computational costs.

Prompt learning can be simplified into three steps. The first step, called “prompt engineering,” applies a function to modify the original input, which uses a template with two empty slots, such as an input slot [x] and an answer slot [z]. The input slot [x] is filled with the original input. For instance, considering a sentiment analysis task, given the template “[X] The movie is [Z]” and the input “I love this movie”, the result will be “I love this movie. The movie is [Z]”.

The second step, called “answer search,” defines a set of permissible answers Z. Following the sentiment analysis example, Z={great, fantastic, bad, . . . }. Then, it is possible to search over Z, looking for the highest scoring text that maximizes the score of the pre-trained LM.

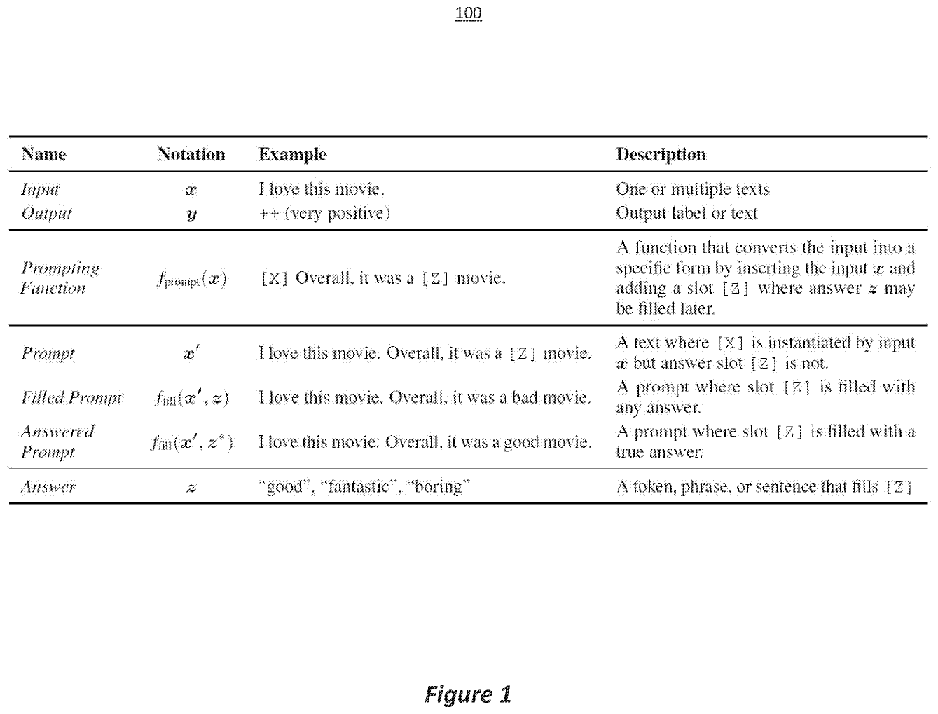

The third step, called “answer mapping,” transforms the highest scoring answer to the highest scoring output. For instance, if the highest scoring answer for the input “I love this movie” is “great,” the final output would be “positive” instead of “negative.” FIG. 1 illustrates all three steps, as shown by label 100.

Prompts can be manually created based on human introspection or automatically generated. Usually they have comparable performance, at the cost of interpretability and computational efforts.

### AutoPrompt

Most prompt based learning models are limited by the manual effort and guesswork required to write prompts. There are a few alternative methods capable of creating prompts automatically. The performance of automatic prompt generation methods is often equivalent to manual generation. Although automatic prompts tend not to be interpretable and have a higher computational cost than those created manually, as expected, generating manual prompts is unfeasible in most real applications.

In this scenario, “AutoPrompt” is an automated tool that can create prompts for a diverse set of tasks. This technique/tool builds customized prompts for a specific task and LM of interest to thereby cause the LMs to produce the desired knowledge.

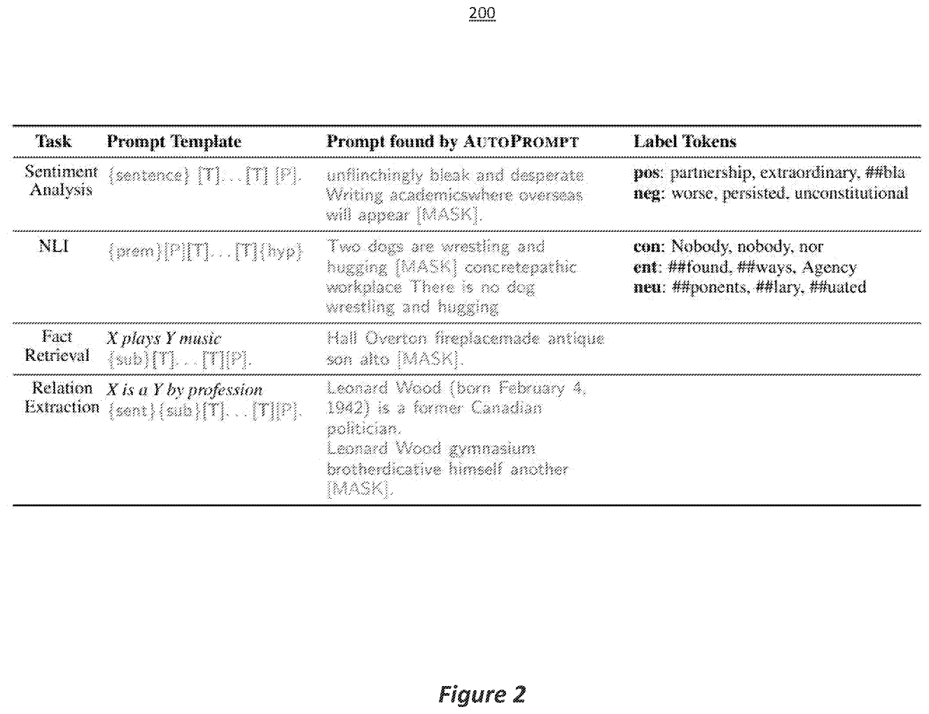

An example will be helpful. Given a task (e.g., sentiment analysis), AutoPrompt creates a prompt by combining the original task inputs (e.g., reviews) with a collection of trigger tokens according to a template. The same set of trigger tokens is used for all inputs and is learned using a variant of the gradient-based search strategy. The LM predictions for the prompt are converted to class probabilities by marginalizing over a set of associated label tokens, which can either be learned or specified ahead of time, enabling the LM to be evaluated the same as one would any other classifier. FIG. 2 illustrates an example of prompts by AutoPrompt, as shown by label 200.

FIG. 2 shows the prompt template, which combines the input, a number of trigger tokens [T], and a prediction token [P]. For classification tasks, AutoPrompt makes predictions by summing the model's probability for several automatically selected label tokens. For fact retrieval and relation extraction, AutoPrompt takes the most likely token predicted by the model.

AutoPrompt outperforms manual prompts and also requires less human effort.

Previous experiments have shown that, in some data-scarce settings, AutoPrompt may be more effective to prompt language models than to fine tune them for sentiment analysis and textual entailment tasks. As will be described in more detail shortly, AutoPrompt is used by the disclosed embodiments to correct data drift.

### Data Drift

The cornerstone of any machine learning model's proposition lies substantially in the dataset used to train the model. When defining the dataset for model training, it is expected that the data reflects the real-world scenario that is being aimed at modeling. Thus, the model is able to learn the behavior of the dataset. When the model is submitted in production, it mimics the data used during the training phase to generalize for new unseen data.

However, the data and scenario that the dataset represented during the training phase can change. Therefore, if the training phase scenario does not or no longer represents the current scenario, it is not possible to guarantee that the deployed machine learning model is generalizing well for this new scenario. In this case, a “data drift” scenario has occurred. Data drift is the variation in the production data from the data that was used to train and validate the model before deploying it in production.

Several factors can cause data to drift. The most common is the time factor. Usually, after deploying a model, this model runs for a pre-established time until the dataset is updated, and the model is retrained. The pre-set interval for a new data collection and model retraining depends on the complexity of the solution, ranging from days to weeks or months. During the time the model is running, data drift may occur.

Other factors, such as seasonality, data errors, behaviors not mapped in the training data, and changes that may impact the behavior mapped in the initial dataset (e.g., pre- and post-COVID-19 pandemic scenarios), can also cause data to drift.

When a data drift is not identified and corrected, the machine learning model starts to make incorrect predictions, its performance is degraded, and any decision based on the model's predictions is compromised. The effort required to address data drift issues varies. In some cases, it is possible to retrain the model with the updated data. In other cases, the model needs to be rebuilt to accommodate the change in the dataset. This process is especially costly. Also, depending on the complexity of the model, it can take months to retrain the model and deploy it in production. The disclosed embodiments employ various techniques designed to avoid those costly endeavors.

### Automatically Updating Prompts in Response to Data Drift

The disclosed embodiments are directed to a pipeline that automatically identifies and corrects possible data drifts by introducing various techniques that update the LM's prompt in an adaptative way. Generally, the disclosed techniques involve three phases, namely, a model deployment phase, an inference phase, and a drift phase. These phases will initially be described at a high level in the following paragraphs. After that initial description, a more detailed explanation will follow.

The model deployment phase (i.e. phase one) generally involves receiving or accessing an LM (e.g., such as, for example, any type of GPT or BERT model) that has been previously trained on a labeled task. This phase further includes receiving the labeled input data from the task training performed by the LM.

This first phase then involves receiving the initial prompt template. The embodiments then run AutoPrompt using the training dataset (e.g., the labeled input data, distributions over that data, etc.) of the LM. The data structure for the context/performance management structure (called a “context management structure,” or “CMS”) is then initialized. The embodiments store the context in the CMS. This context consists of the combination of the prompt, any label tokens that have been generated, and the input labels used for the training dataset. The training dataset is also stored. Later, the training dataset will be used to identify possible drifts during future iterations. The model and the data structure are then deployed.

The inference phase (i.e. phase two) generally involves receiving a new set of input data and then applying the prompt template to that input data. Various predictions are made based on the application of the prompt template to the input data. The input data and the resulting predictions/predicted data (e.g., predicted label data) are saved in the CMS.

The drift phase (i.e. phase three) includes collecting labeled data from previous k inference inputs using an oracle (e.g., a human reviewer or another machine learning entity capable of examining the data and applying labels to the data). The embodiments run drift detection procedures after k inference calls.

Drift detection consists of the following steps. One step involves collecting data (e.g., data distributions or data statistics) from the previous k inputs. Another step involves comparing the collected information against the data stored at the CMS.

If a data drift is identified, then certain actions are performed. For instance, if the collected information is similar to any of the previously stored data, the embodiments return the most appropriate past context. If there is no similar context, then the embodiments rerun AutoPrompt using new training data obtained from the oracle (i.e. the training data that was labeled by the oracle). The context is then stored in the CMS.

If, however, the embodiments determine that performance is degrading, then they will rerun AutoPrompt using the new training data from the oracle. This context will also be stored in the CMS. The embodiments will then update the prompt.

### Further Details

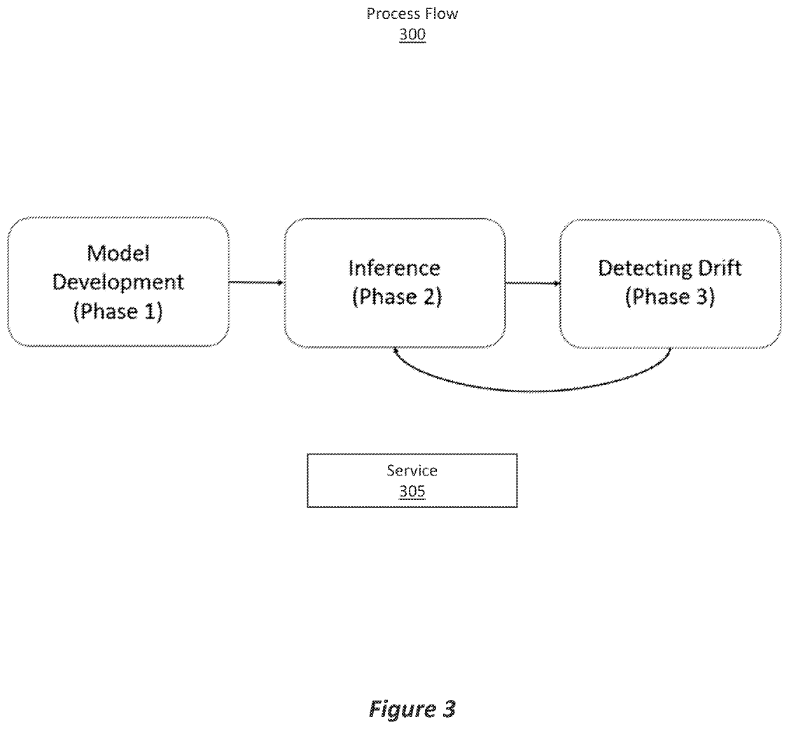

FIG. 3 depicts the main phases or process flow 300 generally described above. It should also be noted how the CMS is a structure that is used to store information and to restore it if needed to help track previous data drifts scenarios.

Process flow 300 can be implemented by service 305. As used herein, the term “service” refers to an automated program that is tasked with performing different actions based on input. In some cases, service 305 can be a deterministic service that operates fully given a set of inputs and without a randomization factor. In other cases, service 305 can be or can include a machine learning (ML) or artificial intelligence engine (or the disclosed LMs). The ML engine enables service 305 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 305 is a cloud service operating in a cloud environment. In some implementations, service 305 is a local service operating on a local device, such as a server. In some implementations, service 305 is a hybrid service that includes a cloud component operating in the cloud and a local component operating on a local device. These two components can communicate with one another.

The Context Management Structure (CMS) (aka “performance management system” or “context management data structure”) is a data structure organized into a list format. Each position in the list is another data structure formed by the dataset distribution and a context. The dataset distribution may be represented by a collection of probabilistic distributions for each feature in the dataset or a multivariate distribution incorporating all features. In the CMS, this information is synthetized in the parameters of the distributions and their type (e.g., gaussian, binomial, etc.). In addition, a context is a combination of a prompt, label tokens, and input labels for the training set at each point of the iteration process.

The input labels are integer numbers, and the prompt and label tokens are a collection of embeddings (e.g., a 32-bit embedding). Each one represents a different word or part of a word. So, the total amount of space needed to store all information may vary depending on the problem at hand.

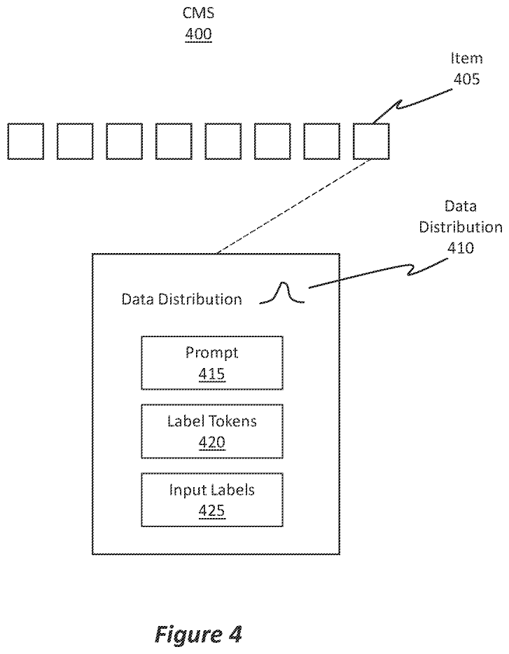

FIG. 4 illustrates the CMS 400. As mentioned, the CMS includes a list of items (e.g., item 405), with each one representing the data distribution 410 of the training data at a given time, the prompt 415, label tokens 420, and input labels 425 of the training dataset.

The process of updating or inserting into the CMS consists of appending a new item to the original list with the same content as the other items in the list (e.g., in O(1) time). The search process in the CMS is similar to any other search process on lists (e.g., O(n) time in the worst scenario).

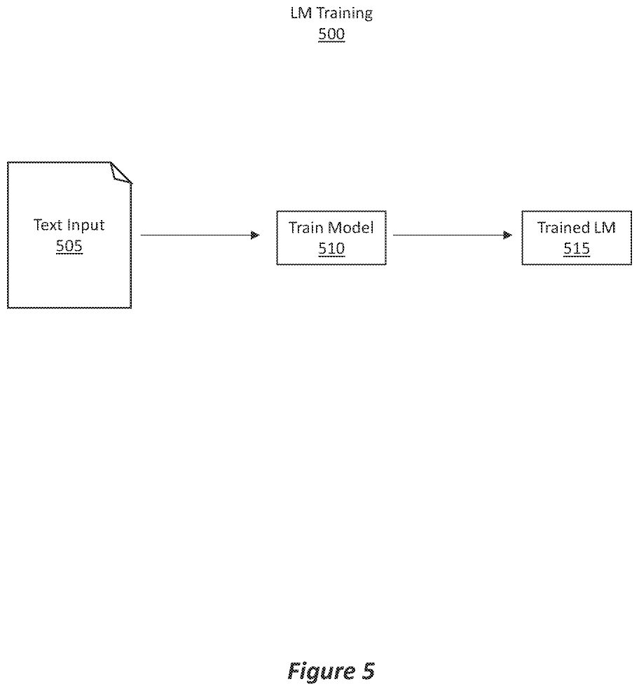

Regarding phase one, one objective of this phase is to build the initial model that will be deployed into production. The initial model should be capable of solving the same task that the LM was trained for. For this reason, in order to create the initial model, it is desirable to receive a trained LM that has been trained for the desired labeled task. The steps for LM training are shown in FIG. 5.

For instance, FIG. 5 shows LM training 500. This training involves using text input 505 to perform a training operation, as shown by train model 510. The result is a trained LM 515.

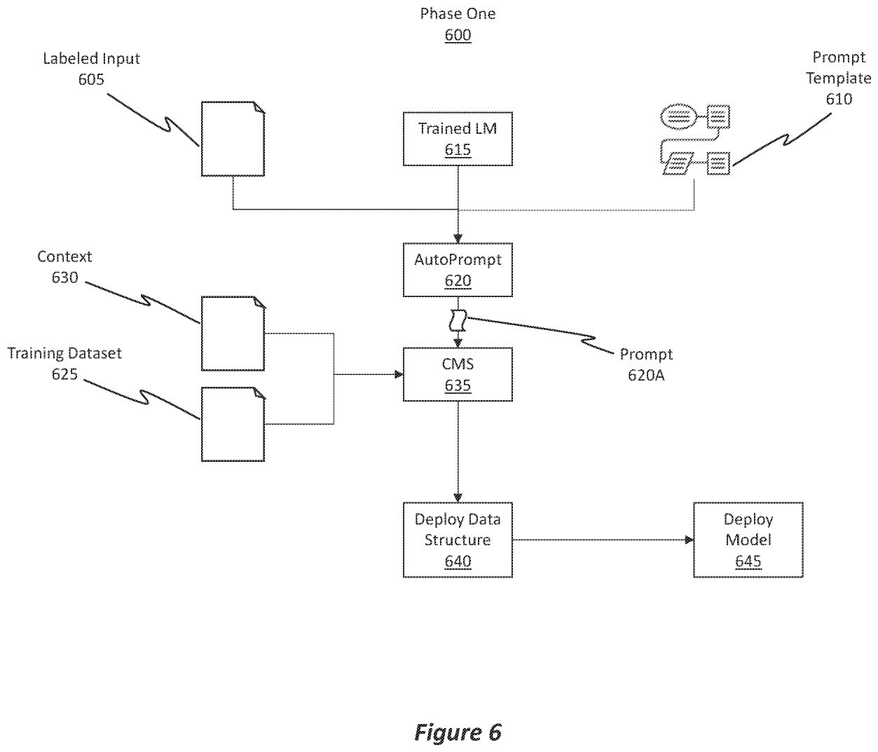

FIG. 6 presents the diagram for phase one 600. In the beginning of phase one 600, the embodiments receive or access the labeled input data 605 used to train the LM.

In addition, a prompt template 610 is created and will be used to generate other prompts. The labeled input data 605 used in the LM, the LM 615 itself, and the prompt template 610 are the inputs to run AutoPrompt 620. In doing so, the embodiments are able to build a prompt-based model by running AutoPrompt 620 with its respected inputs on the same task as the LM was trained. Thus, AutoPrompt acts as the new model that is designed to achieve the same objectives as the LM. This is achieved by feeding AutoPrompt the prompt template and the other information, thereby enabling AutoPrompt to perform the desired operations.

After training and evaluating the AutoPrompt's solution (i.e. a newly generate set of one or more prompts), the embodiments store some information about this process. In particular, the embodiments store the training dataset information 625 (e.g., data distributions) in order to identify possible drifts in the future. In addition, the embodiments also store the context 630 of the solution in the CMS 635. The context 630 consists of the combination of the generated prompt 620A (e.g., produced by AutoPrompt 620), the label tokens, and the input labels for the training set. The embodiments then deploy 640 the data structure and deploy 645 the model in production.

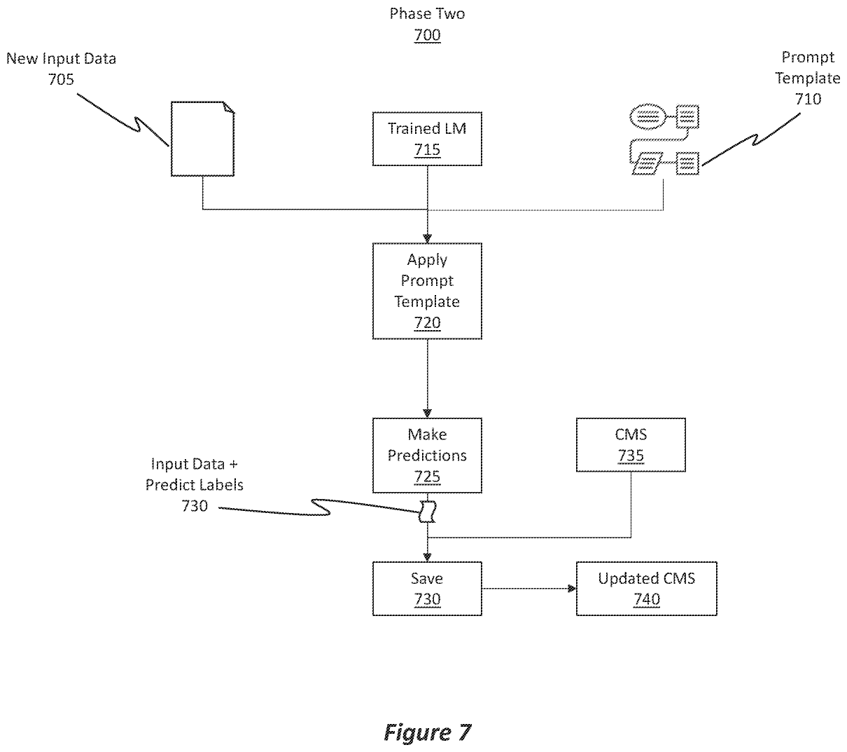

During the inference phase (i.e. the second phase), one objective is to receive new data and to apply the model created in the previous phase. FIG. 7 illustrates phase two 700.

The first step is to receive some new input data 705 and to apply 720 the prompt template 710 defined in the first phase in association to the trained LM 715. After that, the embodiments are able to make predictions 725 using the model deployed in the first phase.

At each inference iteration step, the predictions, the input data, and the predicted labels (labeled as input data+predict labels 730) are saved 735 in the CMS 735 by updating it with new information, as shown by updated CMS 740. In this phase, each inference iteration step represents one new inference input.

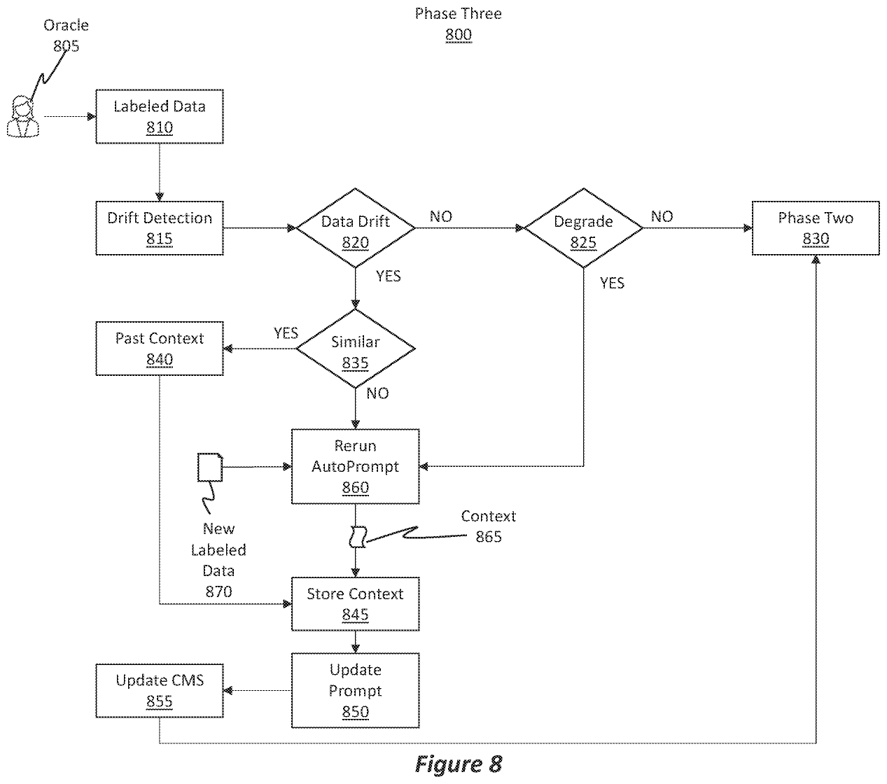

In the third phase, one objective is to collect data and to identify and correct data drift problems or performance degradation. FIG. 8 presents the diagram of phase three 800.

The first part of phase three 800 consists of collecting data from phase two. This data is labeled by an oracle 805, which is capable of providing the labels on the collected data, as shown by labeled data 810. With new data labeled by the oracle 805 and evaluated during the inference phase, it is possible to evaluate the performance of the model that is running, as well as to apply drift detection procedures.

In the second part of phase three, the embodiments are interested in identifying whether there was performance degradation in the model or whether data drift occurred. To identify a possible drop in performance, the embodiments evaluate the model in relation to the data collected in the inference phase and labeled by the oracle. To identify the drift, the embodiments run a drift detection procedure 815. If there has been no drop in model performance (e.g., as shown by degrade 825) and no data drift 820 has been identified, the embodiments return to phase two 830.

For the third part of phase three, two possible scenarios can occur: (i) data drift was identified and (ii) data drift was not identified but there was a drop in model performance.

For the first scenario, data drift is identified. When identifying a data drift, the embodiments verify that the current information is similar 835 to some other state/context previously mapped and stored in the CMS. If this new information is similar to data stored in the past (e.g., as shown by past context 840), the embodiments restore this scenario and return with the most appropriate past context update for the current scenario. By doing this, the embodiments are able to correct the data drift problem. After that, the embodiments store 845 the new context, update 850 the prompt stored, and update 855 the CMS. The embodiments then return to phase two 830.

If there is no similarity with the contexts previously stored in the CMS, then the new labeled data should be used to rerun 860 AutoPrompt using the labeled data 810 to generate new context 865. In that case, the embodiments update the generated prompt in order to solve the data drift problem. Also, the embodiments save 845 the new context, update 850 the prompt for all data, and update 855 the CMS. In both cases, after correcting the data drift, the embodiments return to phase two 830.

Regarding the second scenario, a determination is made that the model's performance is degrading. No data drift has been identified, but model performance is dropping. In this case, the embodiments use the new labeled data 870 to rerun 860 AutoPrompt. In doing so, the embodiments update the data prompt with a new prompt until model performance is re-established. Then, the embodiments store 845 and update (850 and 855) the CMS with the newly generated context and the prompt for all the data. After the re-establishment of the model's performance, the embodiments return to phase two 830.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

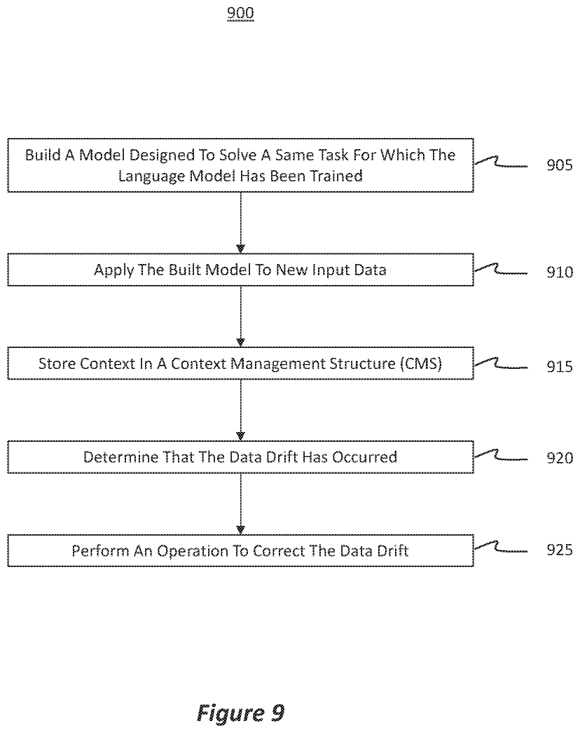

Attention will now be directed to FIG. 9, which illustrates a flowchart of an example method 900 for correcting a data drift of a language model. Method 900 may be implemented by the service 305 of FIG. 3.

Method 900 includes an act (act 905) of building a model (e.g., the AutoPrompt model described earlier) designed to solve a same task for which the language model has been trained. This building process includes a number of steps. One step involves accessing the language model, which has been trained on the desired task. Another step involves accessing labeled input data used to train the language model. Another step involves generating a prompt template, which is usable to generate additional prompts by AutoPrompt. In some scenarios, the prompt template combines the input, a trigger token, and a prediction token. Another step includes building the model (i.e. the AutoPrompt model) using the language model, the labeled input data, and the prompt template. The resulting model is a prompt-based model and is based on AutoPrompt.

In some implementations, AutoPrompt is executed. This execution is performed using the prompt template and is performed using the labeled input data used to train the language model. The prompt template is usable to generate additional prompts via AutoPrompt. For instance, AutoPrompt can be executed using the labeled input data to generate the additional prompts.

Act 910 includes applying the built model to new input data. This application step results in the generation of a prediction, and this prediction includes predicted label data.

Act 915 then includes storing context in a context management structure (CMS).

Notably, the context includes the prompt template, the prediction, and the labeled input data used to train the language model. The CMS includes a list of items, with each item representing a data distribution of at least the labeled input data. In addition to storing the context, the embodiments also store training dataset information in the CMS. The training dataset information includes the data distributions mentioned earlier.

Act 920 includes determining that the data drift has occurred. In some embodiments, this determination is performed by determining that the context is within a threshold level of similarity to a previously stored context. That threshold may be set to any value. For instance, the threshold may be set to a 99% similarity requirement, a 98%, 97%, 96%, 95%, 90%, 80%, 70%, 60%, or any percentage above about 50%. In some embodiments, this determination is performed by determining that the context is not within the threshold level of similarity to a previously stored context. Similarity may be based on how many tokens or parameters are the same or sufficiently similar between the two contexts.

In response to determining that the data drift has occurred, act 925 includes performing an operation to correct the data drift. In some scenarios, the operation to correct the data drift involves (i) selecting a previous past context update, (ii) storing a new context comprising the previous past context update, (iii) updating stored prompts, and (iv) updating the CMS. In some scenarios (e.g., in the scenario where the context is not within the threshold level of similarity), the embodiments may update a generated prompt that was generated based on the context. Doing so can operate to correct the data drift. Correcting the data drift may further include saving a new context and updating the CMS.

Therefore, instead of retraining or fine-tuning a LM, which takes time and huge computational resources, the disclosed embodiments propose to use a prompt learning-based strategy to automatically address data-drifts. The embodiments are beneficially able to store prompts, label tokens, and input labels into different possible contexts aiming to adapt the input data to a new unseen context over time or to reinforce a previous context that has been seen at any time in the past.

Accordingly some embodiments are configured to correct a data drift of a language model. To do so, some embodiments determine that the data drift has occurred. This determination is performed by determining that a context is within a threshold level of similarity to a previously stored context.

Notably, the context is obtained from a context management structure (CMS). The context includes a prompt template, a prediction, and labeled input data used to train the language model. The prompt template, the prediction, and the labeled input data are obtained by applying a built model to new input data. This application results in generation of the prediction comprising predicted label data. The model is designed to solve a same task for which the language model has been trained, and the model is built using a process.

That process includes accessing the language model, which has been trained on the task. The process further includes accessing the labeled input data used to train the language model. The process further includes generating the prompt template, which is usable to generate additional prompts. The process further includes building the model using the language model, the labeled input data, and the prompt template.

The embodiments determine that the data drift has occurred. In response, the embodiment perform an operation to correct the data drift.

### Example Computer Systems

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

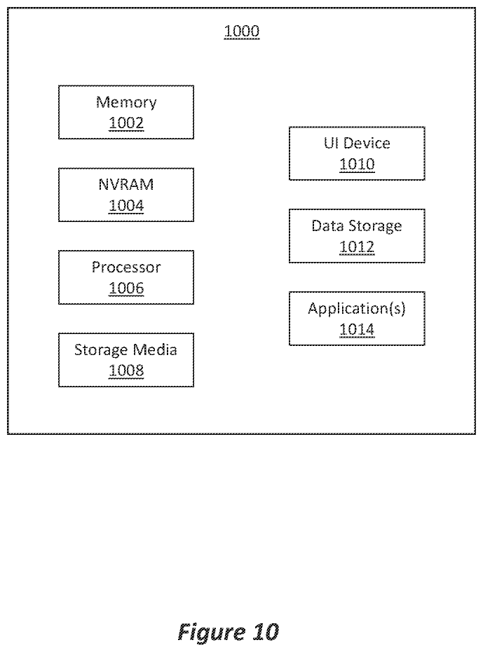

With reference briefly now to FIG. 10, any one or more of the entities disclosed, or implied, by the Figures and/or elsewhere herein, may take the form of, or include, or be implemented on, or hosted by, a physical computing device, one example of which is denoted at 1000. Also, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory 1002 of the physical computing device 1000 may take the form of solid-state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The physical device 1000 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for correcting a data drift of a language model, said method comprising:
determining that the data drift has occurred, wherein said determination is performed by determining that a context is within a threshold level of similarity to a previously stored context, wherein:
the context is obtained from a context management structure (CMS),
the context includes a prompt template, a prediction, and labeled input data used to train the language model,
the prompt template, the prediction, and the labeled input data are obtained by applying a built model to new input data,
said applying results in generation of the prediction comprising predicted label data,
the model is designed to solve a same task for which the language model has been trained, and
the model is built using a process including:
accessing the language model, which has been trained on the task;
accessing the labeled input data used to train the language model;
generating the prompt template, which is usable to generate additional prompts; and
building the model using the language model, the labeled input data, and the prompt template; and
in response to determining that the data drift has occurred, performing an operation to correct the data drift.

2. The method of claim 1, wherein the prompt template combines the input, a trigger token, and a prediction token.

3. The method of claim 1, wherein AutoPrompt is executed using the prompt template and using the labeled input data used to train the language model.

4. The method of claim 1, wherein the CMS includes a list of items, with each item representing a data distribution of at least the labeled input data.

5. The method of claim 1, wherein the prompt template is usable to generate additional prompts.

6. The method of claim 1, wherein said model is a prompt-based model based on AutoPrompt.

7. The method of claim 1, wherein, in addition to storing the context, training dataset information is also stored in the CMS, the training dataset information comprising data distributions.

8. A computer system that corrects a data drift of a language model, said computer system comprising:
one or more processors; and
one or more hardware storage devices that store instructions that are executable by the one or more processors to cause the computer system to:
determines that the data drift has occurred, wherein said determination is performed by determining that a context is within a threshold level of similarity to a previously stored context, wherein:
the context is obtained from a context management structure (CMS),
the context includes a prompt template, a prediction, and labeled input data used to train the language model,
the prompt template, the prediction, and the labeled input data are obtained by applying a built model to new input data,
said applying results in generation of the prediction comprising predicted label data,
the model is designed to solve a same task for which the language model has been trained, and
the model is built using a process including:
accessing the language model, which has been trained on the task;
accessing the labeled input data used to train the language model;
generating the prompt template, which is usable to generate additional prompts; and
building the model using the language model, the labeled input data, and the prompt template; and
in response to determining that the data drift has occurred, performing an operation to correct the data drift.

9. The computer system of claim 8, wherein the operation to correct the data drift involves (i) selecting a previous past context update, (ii) storing a new context comprising the previous past context update, (iii) updating stored prompts, and (iv) updating the CMS.

10. The computer system of claim 8, wherein the prompt template is usable to generate additional prompts.

11. The computer system of claim 8, wherein AutoPrompt is executed using the prompt template to generate additional prompts.

12. The computer system of claim 8, wherein AutoPrompt is executed using the labeled input data to generate additional prompts.

13. The computer system of claim 8, wherein the prompt template combines the input, a trigger token, and a prediction token.

14. The computer system of claim 8, wherein, in addition to storing the context, training dataset information is also stored in the CMS, the training dataset information comprising data distributions.

15. A method for correcting a data drift of a language model, said method comprising:
determining that the data drift has occurred, wherein said determination is performed by determining that a context is not within a threshold level of similarity to a previously stored context, wherein:
the context is obtained from a context management structure (CMS),
the context includes a prompt template, a prediction, and labeled input data used to train the language model,
the prompt template, the prediction, and the labeled input data are obtained by applying a built model to new input data,
said applying results in generation of the prediction comprising predicted label data,
the model is designed to solve a same task for which the language model has been trained, and
the model is built using a process including:
accessing the language model, which has been trained on the task;
accessing the labeled input data used to train the language model;
generating the prompt template, which is usable to generate additional prompts; and
building the model using the language model, the labeled input data, and the prompt template; and
in response to determining that the data drift has occurred, updating a generated prompt that was generated based on the context to correct the data drift.

16. The method of claim 15, wherein the generated prompt is generated using AutoPrompt.

17. The method of claim 15, wherein correcting the data drift further includes saving a new context and updating the CMS.

18. The method of claim 15, wherein AutoPrompt is executed using the prompt template and using the labeled input data used to train the language model.

19. The method of claim 15, wherein the CMS includes a list of items, with each item representing a data distribution of at least the labeled input data.

20. The method of claim 15, wherein the prompt template is usable to generate additional prompts.
